(19) United States
(12) Patent Application Publication
(10) Pub. No.: US 2026/0269349 A1
(43) Pub. Date: Sep. 10, 2026

(54) HEATING VACUUM CHARGING APPARATUS FOR SECONDARY BATTERY

(71) Applicant: SK On Co., Ltd., Seoul (KR)

(72) Inventors: Jae Hyeok YU, Daejeon (KR); Eun Sol KO, Daejeon (KR); Dong Yeop CHU, Daejeon (KR)

(21) Appl. No.: 19/555,905

(22) Filed: Mar. 4, 2026

(30) Foreign Application Priority Data
Mar. 5, 2025 (KR) 10-2025-0028336
Oct. 16, 2025 (KR) 10-2025-0149919

(51) Int. Cl. H01M 10/52; H01M 10/04; H01M 10/44; H01M 10/615; H01M 50/30; H01M 50/627

(52) U.S. Cl. CPC H01M 10/52; H01M 10/04; H01M 10/441; H01M 10/446; H01M 10/615; H01M 50/30; H01M 50/627

(57) ABSTRACT

Proposed is a heating vacuum charging apparatus for a secondary battery, the apparatus including a hopper configured to apply pressure through a filling port of a secondary battery housed in a tray, a pressure passage part configured to supply pressure to the hopper, and an on-off controller configured to open or close the hopper depending on a presence or absence of the secondary battery in the tray. According to the apparatus, pressure is transmitted to a secondary battery through the hopper only when the secondary battery is present in the tray, and unnecessary pressure loss is prevented when the tray is empty, thereby improving heat vacuum charging performance.

### CROSS REFERENCE TO RELATED APPLICATION

The present application claims priority to Korean Patent Application No. 10-2025-0149919, filed Oct. 16, 2025, which claims priority to Korean Patent Application No. 10-2025-0028336, filed Mar. 5, 2025, the entire contents of which is incorporated herein for all purposes by this reference.

### BACKGROUND

### Technical Field

The present disclosure relates to a heating vacuum charging apparatus for secondary batteries.

### Description of the Related Art

Secondary batteries are widely used as a key energy source in various industrial fields in recent years, particularly in electric vehicles, energy storage systems, and portable electronic devices. The secondary batteries offer high economic efficiency and performance through repeated charging and discharging, but meticulous process control and quality management are crucial throughout the manufacturing process.

As one of the manufacturing processes for secondary batteries, the electrolyte injection step may be a critical factor in determining the performance and stability of the batteries. During the electrolyte injection process, uniform electrolyte impregnation must be achieved, and technologies are required to prevent the introduction of impurities and to properly control internal pressure. To this end, apparatuses capable of performing a heat vacuum charge (HVC) process have been developed, and each process needs to be precisely controlled.

In general, in the HVC process in which a plurality of secondary batteries is processed simultaneously, some channels of a tray may be left empty without secondary batteries, and as a result, pressure used in the process may leak through hoppers corresponding to the empty channels. Such pressure leakage not only degrades the uniformity of the process but may also reduce the overall energy efficiency of the apparatus.

Accordingly, there is a need for a technology capable of precisely controlling the opening and closing of a hopper such that pressure is transmitted through the hopper only when a secondary battery is in place, and unnecessary pressure loss is prevented when the corresponding spot is empty.

### SUMMARY

According to an aspect of the present disclosure, provided is a heating vacuum charging apparatus for a secondary battery, configured such that pressure is transmitted to a secondary battery through a hopper only when the secondary battery is present in a tray, and unnecessary pressure loss is prevented when the tray is empty.

According to another aspect of the present disclosure, provided is a heating vacuum charging apparatus for a secondary battery, which can be widely applied in green technology fields utilizing batteries, such as electric vehicles, battery charging stations, and renewable energy systems including solar power generation and wind power generation.

A heating vacuum charging apparatus for a secondary battery according to an embodiment of the present disclosure may include: a hopper configured to apply pressure through a filling port of a secondary battery housed in a tray; a pressure passage part configured to supply pressure to the hopper; and an on-off controller configured to open or close the hopper depending on a presence or absence of the secondary battery in the tray.

In this case, an upper side of the hopper may be configured to be in constant communication with the pressure passage part to receive pressure.

In addition, a lower side of the hopper may be provided with the on-off controller and is configured to be able to come into contact with the filling port of the secondary battery.

In addition, the pressure passage part may be provided such that negative pressure is applied.

In this case, the pressure passage part may include: a main pipe configured to receive pressure from an external source; and a plurality of distribution pipes branching from the main pipe, wherein each of the distribution pipes may be individually provided with one hopper.

The main pipe may be provided to maintain a constant pressure, and the distribution pipes may be configured such that the pressure of the main pipe is selectively transmitted only to a hopper in an open state according to opening and closing of the on-off controller installed for each individual hopper.

The on-off controller may be configured to be opened when in contact with the secondary battery in the tray.

The on-off controller may be configured to block an opening of an individual hopper corresponding to an empty secondary battery channel in the tray, so as to prevent pressure loss in the pressure passage part.

In addition, the on-off controller may include: a housing disposed at the bottom of the hopper, and in which a flow path is formed; a constriction part configured to reduce a cross-sectional area of the flow path of the housing; a stem part configured to pass through the constriction part to block the flow path and to move vertically according to contact with the filling port; and a valve groove recessed on an outer periphery of the stem part, and configured to form a flow path space between the stem part and the constriction part when the stem part moves upward.

In addition, the stem part may further include a sealing part configured to come into close contact with the constriction part when the stem part descends, in order to block the internal flow path of the housing.

In addition, the stem part may further include an elastic member configured to lower the stem part when no secondary battery is present in the tray.

In addition, the housing may further include a sealing member that maintains airtightness between a bottom of the housing and the filling port of the secondary battery and prevents pressure leakage.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, pressure is transmitted to a secondary battery through a hopper only when the secondary battery is present in a tray, and unnecessary pressure loss is prevented when the tray is empty, thereby improving heat vacuum charging performance.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a side view schematically showing a heating vacuum charging apparatus for a secondary battery according to an embodiment of the present disclosure;

FIG. 2 is a side view showing a state in which some channels of a tray are empty of secondary batteries in the heating vacuum charging apparatus for a secondary battery according to an embodiment of the present disclosure;

FIG. 3 is an enlarged view of portion “A” of FIG. 2, showing a closed state of an on-off controller according to the present disclosure;

FIG. 4 is an enlarged view of portion “B” of FIG. 2, showing an open state of the on-off controller according to the present disclosure; and

FIG. 5 is an exploded perspective view showing the configuration of the on-off controller according to the present disclosure.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

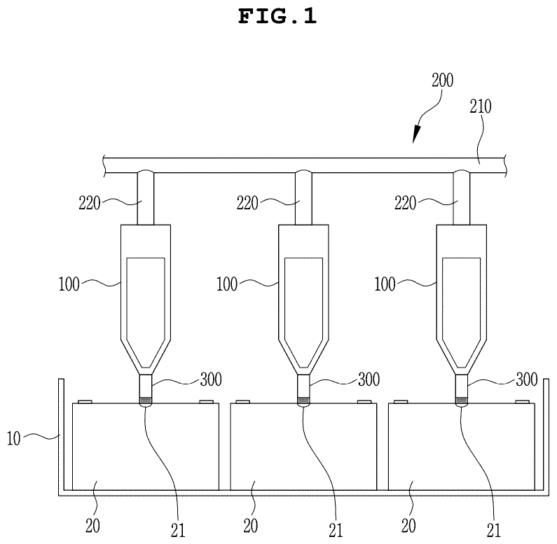

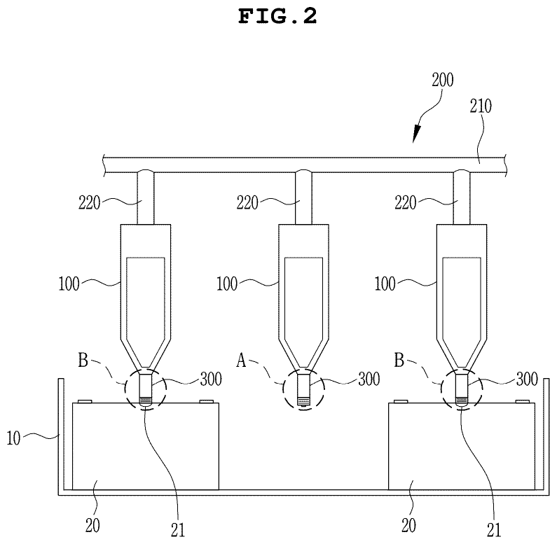

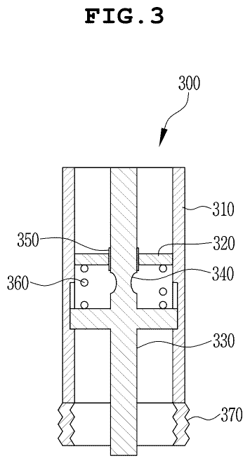

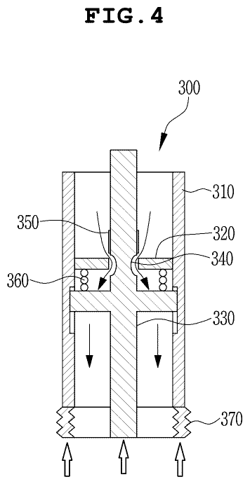

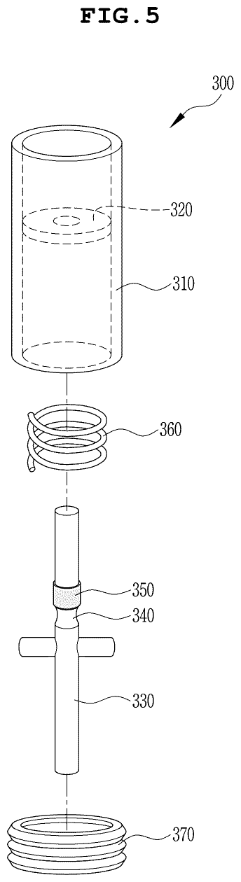

FIG. 1 is a side view schematically showing a heating vacuum charging apparatus for a secondary battery according to an embodiment of the present disclosure; FIG. 2 is a side view showing a state in which some channels of a tray are empty of secondary batteries in the heating vacuum charging apparatus for a secondary battery according to an embodiment of the present disclosure; FIG. 3 is an enlarged view of portion “A” of FIG. 2, showing a closed state of an on-off controller according to the present disclosure; FIG. 4 is an enlarged view of portion “B” of FIG. 2, showing an open state of the on-off controller according to the present disclosure; and FIG. 5 is an exploded perspective view showing the configuration of the on-off controller according to the present disclosure.

A heating vacuum charging apparatus for a secondary battery according to an embodiment of the present disclosure may include: a hopper 100 configured to apply pressure through a filling port 21 of a secondary battery 20 housed in a tray 10; a pressure passage part 200 configured to supply pressure to the hopper 100; and an on-off controller 300 configured to open or close the hopper 100 depending on the presence or absence of the secondary battery 20 in the tray 10.

As shown in FIG. 1, the hopper 100 may function to transmit pressure supplied from an external source to the interior of the secondary battery 20 through the filling port 21 of the secondary battery 20.

A plurality of secondary batteries 20 may be accommodated in the tray 10 used in a heat vacuum charging process. After the secondary batteries 20 are placed in the tray 10, as the tray 10 moves along a predetermined path, the filling port 21 of the secondary battery 20 may be directly or indirectly connected to the lower side of the hopper 100.

Accordingly, the hopper 100 may receive pressure supplied through the pressure passage part 200 and transmit the received pressure to the interior of the secondary battery 20 through the filling port 21.

In this case, the upper side of the hopper 100 may be configured to be constantly connected to the pressure passage part 200 to receive pressure.

Referring to FIG. 1, the hopper 100 may be formed with a wide upper portion and a narrow lower portion, and the upper portion of the hopper 100 may be configured to be continuously in fluid communication (hereinafter referred to as “in communication”) with the pressure passage part 200.

Since the upper portion of the hopper 100 is in continuous communication with the pressure passage part 200, the hopper 100 may always be subjected to the same pressure as the pressure in the pressure passage part 200. The hopper 100 may transmit the pressure supplied through the pressure passage part 200 into the interior of the hopper 100 while maintaining the supplied pressure at a substantially constant level.

An internal flow path is formed within the main body of the hopper 100, such that pressure supplied from the pressure passage part 200 may pass through the internal flow path and be transmitted to the filling port 21 of the secondary battery 20 by means of the on-off controller 300.

In addition, at the bottom of the hopper 100, the on-off controller 300 may be installed so as to be in contact with the filling port 21 of the secondary battery 20.

Through the continuously communicating structure between the pressure passage part 200 and the hopper 100, the pressure acting within the hopper 100 may be regulated by the on-off controller 300 installed at the bottom of the hopper 100, such that the transmission of pressure is controlled according to whether the hopper 100 is in an open or closed state.

The on-off controller 300 installed at the bottom of the hopper 100 may be configured to contact or closely engage with the filling port 21 of the secondary battery 20. When the on-off controller 300 comes into contact with the filling port 21 of the secondary battery 20, the controller 300 is opened so that pressure is applied, allowing pressure to be transmitted into the interior of the secondary battery 20 through the filling port 21. The configuration and operating principle of the on-off controller 300 will be described in detail later.

The pressure passage part 200 may be provided to supply a predetermined pressure to the hopper 100.

The pressure passage part 200 serves to supply pressure in an apparatus or equipment performing a heat vacuum charging process, and the supplied pressure may be either a positive pressure or a negative pressure.

Positive pressure is primarily used during the process of injecting electrolyte into the interior of the secondary battery 20, whereas negative pressure may be used to remove gas from the interior of the secondary battery 20 or to create a vacuum state.

In this case, the pressure passage part 200 according to the present disclosure may be provided such that negative pressure acts.

However, the pressure passage part 200 of the present disclosure is not limited to always applying negative pressure, and it is also possible for positive or negative pressure to act selectively as required.

That is, during electrolyte injection into the interior of the secondary battery 20, the pressure passage part 200 may be supplied with positive pressure, while during gas removal from the interior of the secondary battery 20 or creation of a vacuum state, the pressure passage part 200 may be supplied with negative pressure.

In this case, the pressure passage part 200 may include: a main pipe 210 that receives pressure from an external source; and a plurality of distribution pipes 220 branching from the main pipe 210, with one hopper 100 individually provided for each of the distribution pipes 220.

As shown in FIG. 1, the pressure passage part 200 may include the main pipe 210 and the distribution pipes 220.

The main pipe 210 is provided to be in communication with an external pressure source (not shown) so as to receive a predetermined pressure.

The distribution pipe 220 branches from the main pipe 210 and the plurality of distribution pipes 220 may be provided, formed at predetermined intervals. The distribution pipes 220 may be arranged such that the number and positions thereof correspond to a plurality of secondary batteries 20 accommodated on the tray 10, with one distribution pipe 220 provided for each secondary battery 20. Each distribution pipe 220 may be individually connected to a respective hopper 100.

That is, since the distribution pipes 220 and hoppers 100 may be provided to correspond to the number and positions of the secondary batteries 20, each distribution pipe 220 can deliver the required pressure to the respective hopper 100 thereof.

In this case, the main pipe 210 is provided to maintain a predetermined pressure, and the distribution pipes 220 may be configured such that, depending on the open or closed state of the on-off controller 300 installed for each individual hopper 100, the pressure from the main pipe 210 is selectively transmitted only to the hoppers 100 in an open state.

As shown in FIG. 2, each individual hopper 100, which is independently installed for each distribution pipe 220, may be provided with the on-off controller 300 installed individually.

The on-off controller 300 may be located at the bottom of each individual hopper 100, and depending on the open or closed state of the on-off controller 300, the hopper 100 may be in an open state, in which pressure from the pressure passage part 200 acts, or in a closed state.

Hereinafter, the on-off controller 300 will be described in more detail.

The on-off controller 300 may control to open or close the hopper 100 depending on the presence or absence of the secondary battery 20 in the tray 10.

To be specific, referring to FIG. 2, when a secondary battery 20 is present in a predetermined channel of the tray 10, the on-off controller 300 of the hopper 100 corresponding to that channel contacts the filling port 21 of the secondary battery 20 and opens, thereby opening the internal flow path of the hopper 100. Accordingly, the pressure acting on the hopper 100 is applied to the interior of the secondary battery 20 through the filling port 21.

In addition, as shown in FIG. 2, when a predetermined channel in the tray 10 is empty of a secondary battery 20, the on-off controller 300 installed in the individual hopper 100 corresponding to that channel cannot contact a secondary battery 20, and thus remains closed.

That is, since the on-off controller 300 remains in a closed state, the internal flow path of the hopper 100 is not opened and is blocked. Accordingly, the hopper 100 is prevented from transmitting pressure, which can prevent leakage of pressure from the pressure passage part 200.

As such, the on-off controller 300 may be configured to open upon contact with a secondary battery 20 in the tray 10.

In addition, the on-off controller 300 may be configured to block the opening of an individual hopper 100 corresponding to a channel in the tray 10 that is empty of a secondary battery 20, thereby preventing pressure loss from the pressure passage part 200.

Therefore, the on-off controller 300 of a hopper 100 that contacts a secondary battery 20 in the tray 10 is in an open state, whereas the on-off controller 300 of a hopper 100 that does not contact a secondary battery 20 is in a closed state. Accordingly, upon contact with a secondary battery 20, pressure may be transmitted into the interior of the secondary battery 20 due to the opening of the hopper 100, and in the absence of contact with a secondary battery 20, pressure loss may be prevented by blocking the hopper 100.

To be specific, the on-off controller 300 may include: a housing 310 disposed at the bottom of the hopper 100, and in which a flow path is formed; a constriction part 320 that reduces the cross-sectional area of the flow path of the housing 310; a stem part 330 passing through the constriction part 320 to block the flow path and movable up and down depending on contact with the filling port 21; and a valve groove 340 recessed on the outer periphery of the stem part 330, and configured to form a flow path space between the stem part 330 and the constriction part 320 when the stem part 330 moves upward.

As shown in FIGS. 3 and 4, the housing 310 serves as a component forming the overall exterior of the on-off controller 300 and may be disposed at the bottom of the hopper 100. The housing 310 may be installed in a structure inserted into the lower interior of the hopper 100, or may be installed in a structure extending from the lower end of the hopper 100 toward the filling port 21 of the secondary battery 20.

The housing 310 may receive pressure acting on the hopper 100 and may have a predetermined flow path formed therein to allow a fluid, such as electrolyte or gas, to pass through. Accordingly, pressure may act through the flow path within the housing 310, and when the pressure is positive, electrolyte may pass through the housing 310, whereas when the pressure is negative, gas from the interior of the secondary battery 20 may pass through.

The constriction part 320 may be provided to reduce the cross-sectional area of the flow path of the housing 310. The constriction part 320 may have a hollow ring shape with a central opening and may be installed in a structure inserted into the housing 310.

In addition, the constriction part 320 may be integrally formed with the housing 310 and extend from the inner wall toward the center of the housing 310, and the center of the constriction part 320 may be provided as a hollow ring. That is, the constriction part 320 may provide a structure in which only a portion of the cross-sectional area of the flow path of the housing 310 is open, while the remainder is closed.

The stem part 330 may have an overall cylindrical shape and extend through the constriction part 320 within the housing 310 so as to block the flow path formed by the constriction part 320. The stem part 330 may be configured to move vertically within the housing 310 depending on contact with the filling port 21 of the secondary battery 20.

When the on-off controller 300 contacts the filling port 21, the stem part 330 rises within the housing 310 due to the reaction force from the filling port 21, and when the on-off controller 300 does not contact the filling port 21, the stem part 330 may descend by gravity. That is, the stem part 330 may be configured to move upward or downward while passing through the constriction part 320 within the housing 310 depending on contact with the filling port 21.

As shown in FIG. 3, the valve groove 340 may be an element recessed on the outer circumference of the stem part 330. The valve groove 340 may be provided in the form of a band continuously recessed on the outer circumference of the stem part 330.

As shown in FIG. 4, the valve groove 340 may be positioned so that, when the stem part 330 rises, a predetermined flow path space is created between the stem part 330 and the constriction part 320. In other words, the valve groove 340 may be formed on the stem part 330 such that, upon upward movement of the stem part 330, a flow path space is created between the stem part 330 and the constriction part 320, allowing communication between two different spaces within the housing 310 partitioned by the constriction part 320 by means of the valve groove 340.

Thus, as shown in FIG. 3, when the stem part 330 descends, the stem part 330 completely closes the constriction part 320, so that the flow path within the housing 310 is blocked. On the other hand, when the stem part 330 rises, the valve groove 340 rises to a position opposing the constriction part 320, thereby opening the flow path within the housing 310.

In addition, the stem part 330 may further include a sealing part 350 that comes into close contact with the constriction part 320 when the stem part 330 descends, in order to block the internal flow path of the housing 310.

As shown in FIG. 5, the sealing part 350 is configured to enhance the airtightness between the stem part 330 and the constriction part 320, and, when the stem part 330 is in the lowered position, may come into close contact with the inner diameter of the constriction part 320 to block the internal flow path of the housing 310.

The sealing part 350 may be positioned to face the constriction part 320 when the stem part 330 is in the lowered state, and may be formed continuously in the circumferential direction on the outer periphery of the stem part 330.

The sealing part 350 may be made of a material such as silicone or rubber to enhance contact tightness with the constriction part 320. As shown in FIG. 3, when the stem part 330 is in the lowered state, the sealing part 350 is provided on the outer periphery of the stem part 330 facing the inner diameter of the constriction part 320, thereby blocking the flow of fluid passing through the inner diameter of the constriction part 320.

In addition, the stem part 330 may further include an elastic member 360 configured to lower the stem part 330 when no secondary battery 20 is present in the tray 10.

Referring to FIGS. 3 to 5, the elastic member 360 may provide an elastic force to the stem part 330 to lower the stem part 330 when there is no secondary battery 20 in the tray 10.

When a secondary battery 20 is present in the tray 10, the stem part 330 rises due to contact force with the secondary battery 20. However, when no secondary battery is present in the tray 10, although the stem part 330 may descend under gravity, the stem part 330 may become stuck and not descend smoothly due to the influence of various fluids. Accordingly, the elastic member 360 may forcibly move the stem part 330 downward.

To install the elastic member 360 on the stem part 330, the stem part 330 may be provided with a support part protruding below the valve groove 340 and extending toward the inner diameter of the housing 310. The elastic member 360 may be installed between the constriction part 320 and the support part, and may elastically expand as shown in FIG. 3 or elastically contract as shown in FIG. 4.

In this case, the end of the support part may be inserted into a guide groove recessed along the vertical movement direction of the stem part 330 on the inner circumferential surface of the housing 310. Accordingly, the reciprocal vertical movement of the stem part 330 may be restricted by the support part and the guide groove.

In addition, the housing may further comprises a sealing member that maintains airtightness between a bottom of the housing and the filling port of the secondary battery and prevents pressure leakage.

As shown in FIGS. 3 to 5, the sealing member 370 may maintain airtightness between the housing 310 and the filling port 21 while the stem part 330 moves up and down in contact with the filling port 21, thereby preventing pressure leakage.

The sealing member 370 allows the pressure applied through the hopper 100 and the on-off controller 300 to be transmitted to the filling port 21 of the secondary battery 20 without leakage. In addition, the sealing member 370 may also serve to prevent gas inside the secondary battery 20 from leaking to the outside when the gas flows toward the hopper 100 side due to the applied pressure (e.g., negative pressure), and to prevent electrolyte from leaking to the outside when the electrolyte is injected into the interior of the secondary battery 20 under the applied pressure (e.g., positive pressure).

The sealing member 370 may be provided in the form of a bellows structure capable of length extension so as not to be affected by a separation distance between the on-off controller 300 and the filling port 21. Accordingly, even when the distance between an end of the on-off controller 300 and the filling port 21 is not constant, the sealing member 370 may accommodate the variation through flexible length changes.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A heating vacuum charging apparatus for a secondary battery, the apparatus comprising:
a hopper configured to apply pressure through a filling port of a secondary battery housed in a tray;
a pressure passage part configured to supply pressure to the hopper; and
an on-off controller configured to open or close the hopper depending on a presence or absence of the secondary battery in the tray.

2. The apparatus of claim 1, wherein an upper side of the hopper is configured to be in constant communication with the pressure passage part to receive pressure.

3. The apparatus of claim 1, wherein a lower side of the hopper is provided with the on-off controller and is configured to be able to come into contact with the filling port of the secondary battery.

4. The apparatus of claim 1, wherein the pressure passage part is provided such that negative pressure is applied.

5. The apparatus of claim 1, wherein the pressure passage part comprises:
a main pipe configured to receive pressure from an external source; and
a plurality of distribution pipes branching from the main pipe,
wherein each of the distribution pipes is individually provided with one hopper.

6. The apparatus of claim 5, wherein the main pipe is provided to maintain a constant pressure, and the distribution pipes are configured such that the pressure of the main pipe is selectively transmitted only to a hopper in an open state according to opening and closing of the on-off controller installed for each individual hopper.

7. The apparatus of claim 1, wherein the on-off controller is configured to be opened when in contact with the secondary battery in the tray.

8. The apparatus of claim 7, wherein the on-off controller is configured to block an opening of an individual hopper corresponding to an empty secondary battery channel in the tray, so as to prevent pressure loss in the pressure passage part.

9. The apparatus of claim 1, wherein the on-off controller comprises:
a housing disposed at a bottom of the hopper, and in which a flow path is formed;
a constriction part configured to reduce a cross-sectional area of the flow path of the housing;
a stem part configured to pass through the constriction part to block the flow path and to move vertically according to contact with the filling port; and
a valve groove recessed on an outer periphery of the stem part, and configured to form a flow path space between the stem part and the constriction part when the stem part moves upward.

10. The apparatus of claim 9, wherein the stem part further comprises:
a sealing part configured to come into close contact with the constriction part when the stem part descends, in order to block the internal flow path of the housing.

11. The apparatus of claim 9, wherein the stem part further comprises:
an elastic member configured to lower the stem part when no secondary battery is present in the tray.

12. The apparatus of claim 9, wherein the housing further comprises a sealing member that maintains airtightness between a bottom of the housing and the filling port of the secondary battery and prevents pressure leakage.
